(19) United States
(12) Patent Application Publication
(10) Pub. No.: US 2017/0038517 A1
(43) Pub. Date: Feb. 9, 2017

(54) BRIGHTNESS ENHANCEMENT FILM, BACKLIGHT MODULE AND DISPLAY DEVICE

(71) Applicant: BOE TECHNOLOGY GROUP CO., LTD., Beijing (CN)

(72) Inventor: Yoonsung UM, Beijing (CN)

(73) Assignee: BOE TECHNOLOGY GROUP CO., LTD., Beijing (CN)

(21) Appl. No.: 15/148,003

(22) Filed: May 6, 2016

(30) Foreign Application Priority Data
Aug. 7, 2015 (CN) 201510484520.9

(51) Int. Cl. F21V 8/00; G02B 5/22

(52) U.S. Cl. CPC G02B 6/0053; G02B 5/22

(57) ABSTRACT

The present disclosure provides a brightness enhancement film. The brightness enhancement film includes a plurality of color filter layers in different colors, and the color filter layer in one color has a thickness different from any one of thicknesses of the color filter layers in the other colors.

### CROSS-REFERENCE TO RELATED APPLICATION

The present application claims a priority of the Chinese patent application No. 201510484520.9 filed on Aug. 7, 2015, which is incorporated herein by reference in its entirety.

### TECHNICAL FIELD

The present disclosure relates to the field of display technology, in particular to a brightness enhancement film, a backlight module and a display device.

### BACKGROUND

Liquid crystal display (LCD), as the most popular and a non-luminous display device, can merely display an image by virtue of a backlight module. The backlight module mainly includes a backlight source, a light guide plate and optical films. The optical films mainly include a reflection film, a diffusion film and a brightness enhancement film.

The brightness enhancement film functions as to adjust light beams beyond a viewing field of a viewer to be within the viewing field, i.e., to converge the light beams, so as to improve a light utilization rate. Through a total reflection function of the brightness enhancement film, the light beam having an incident angle within a certain range may pass through the brightness enhancement film, i.e., an emergent angle of the light beam may be controlled by the brightness enhancement film. In addition, the light beam having an incident angle beyond the range may be reflected back to the backlight module, so as to be reused. In this way, most of the light beams passing through the brightness enhancement film have the emergent angles of ±35° relative to a normal of the brightness enhancement film, and merely a small part of the light beams have the emergent angles larger than 35°, so it is able to improve the brightness at the viewing field. Usually, the brightness enhancement film includes hundreds of first optically anisotropic layers and second optically isotropic layers arranged alternately and arranged one on top of the other, and a plurality of color filter layers in different colors.

White-light chromaticity coordinates of the LCD usually depends on a light-transmitting area ratio of red (R), green (G) and blue (B) sub-pixel regions as well as a spectrum of the backlight source. In order to meet the requirements on different product specifications, usually it is necessary to adjust the white-light chromaticity coordinates of the LCD. As one of the methods in related art, in the case that the other conditions are constant, a pattern of a black matrix may be adjusted, so as to adjust the light-transmitting area ratio of the RGB sub-pixel regions, thereby to adjust the white-light chromaticity coordinates of the LCD. However, in this method, for the sub-pixel with the maximum light-transmitting area, its light-transmitting area cannot be adjusted due to the limitations on a pixel size, a manufacture process and etc. Instead, the light-transmitting area ratio of the RGB sub-pixel regions may be adjusted merely by reducing the light-transmitting areas of the other sub-pixels. As a result, the brightness of the LCD will be reduced.

### SUMMARY

An object of the present disclosure is to provide a brightness enhancement film, a backlight module and a display device, so as to meet the requirements on different white-light chromaticity coordinates by adjusting the brightness enhancement film, and ensure the brightness of the display device.

In one aspect, the present disclosure provides in some embodiments a brightness enhancement film, including a plurality of color filter layers in different colors. The color filter layer in one color has a thickness different from any one of thicknesses of the color filter layers in the other colors.

Alternatively, the color filter layer in one color has a thickness greater than any one of thicknesses of the color filter layers in the other colors.

Alternatively, the plurality of color filter layers in different colors includes a red color filter layer, a blue color filter layer and a green color filter layer.

Alternatively, a thickness of the red color filter layer is less than a thickness of the green color filter layer, and the thickness of the green color filter layer is less than a thickness of the blue color filter layer.

Alternatively, a thickness of the blue color filter layer is less than a thickness of the green color filter layer, and the thickness of the green color filter layer is less than a thickness of the red color filter layer.

Alternatively, a thickness of the blue color filter layer is less than a thickness of the green color filter layer, and a thickness of the red color filter layer is less than the thickness of the green color filter layer.

Alternatively, the thickness of the blue color filter layer is identical to the thickness of the red color filter layer.

Alternatively, the brightness enhancement film further includes, a plurality of uniaxial optical layers and a plurality of biaxial optical layers arranged alternately and arranged one on top of the other.

In another aspect, the present disclosure provides in some embodiments a backlight module including a backlight source, a light guide plate, and the above-mentioned brightness enhancement film.

In yet another aspect, the present disclosure provides in some embodiments a display device including a display panel and the above-mentioned backlight module.

According to the embodiments of the present disclosure, the color filter layer in one color in the brightness enhancement film has a thickness different from any one of thicknesses of the color filter layers in the other colors, and the white-light chromaticity coordinates of the brightness enhancement film may vary along with variations of different thicknesses of the color filter layers in different colors, so it is able to meet the requirements on different white-light chromaticity coordinates by adjusting the thicknesses of the color filter layers. In addition, the chromaticity coordinates of the brightness enhancement film are not constant any more, and they may vary along with variation of the thicknesses of the color filter layers, so it is able to change the chromaticity coordinates of the brightness enhancement film by adjusting the thickness of the color filter layer. As a result, it is able to meet the requirements on different white-light chromaticity coordinates of the display device and ensure the brightness of the display device.

### BRIEF DESCRIPTION OF THE DRAWINGS

FIG. 1 is a schematic view showing color filter layers of a brightness enhancement film in related art;

FIG. 2 is a schematic view showing a brightness enhancement film where a blue color filter layer has a thickness greater than thicknesses of a green color filter layer and a red color filter layer according to one embodiment of the present disclosure;

FIG. 3 is another schematic view showing the brightness enhancement film where the red color filter layer has a thickness greater than thicknesses of the green color filter layer and the blue color filter layer according to one embodiment of the present disclosure; and

FIG. 4 is yet another schematic view showing the brightness enhancement film where the green color filter layer has a thickness greater than thicknesses of the red color filter layer and the blue color filter layer according to one embodiment of the present disclosure.

### REFERENCE SIGN LIST

1, 10 red color filter layer
2, 20 green color filter layer
3, 30 blue color filter layer

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “a” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

In the related art, in the case that white-light chromaticity coordinates of an LCD are adjusted, usually the brightness of the LCD may be adversely affected. The present disclosure provides in some embodiments a brightness enhancement film, a backlight module and a display device, so as to meet the requirements on different white-light chromaticity coordinates by adjusting the brightness enhancement film, and ensure the brightness of the display device.

The present disclosure provides in some embodiments a brightness enhancement film, which includes a plurality of color filter layers in different colors. The color filter layer in one color has a thickness different from any one of thicknesses of the color filter layers in the other colors.

According to the embodiments of the present disclosure, the color filter layer in one color in the brightness enhancement film has a thickness different from any one of thicknesses of the color filter layers in the other colors, and the white-light chromaticity coordinates of the brightness enhancement film may vary along with variations of different thicknesses of the color filter layers in different colors, so it is able to meet the requirements on different white-light chromaticity coordinates by adjusting the thicknesses of the color filter layers. In addition, the chromaticity coordinates of the brightness enhancement film are not constant any more, and they may vary along with variation of the thicknesses of the color filter layers, so it is able to change the chromaticity coordinates of the brightness enhancement film by adjusting the thickness of the color filter layer. As a result, it is able to meet the requirements on different white-light chromaticity coordinates of the display device and ensure the brightness of the display device.

Alternatively, the color filter layer in one color has a thickness greater than any one of thicknesses of the color filter layers in the other colors, so as to enable the chromaticity coordinates of the brightness enhancement film to be changed in a direction toward the color corresponding to the color filter layer with a larger thickness.

Alternatively, the plurality of color filter layers in different colors may include a red color filter layer, a blue color filter layer and a green color filter layer.

In an alternative embodiment of the present disclosure, a thickness of the red color filter layer is less than a thickness of the green color filter layer, and the thickness of the green color filter layer is less than a thickness of the blue color filter layer, so as to enable the chromaticity coordinates of the brightness enhancement film to be changed in a direction toward blue.

In another alternative embodiment of the present disclosure, a thickness of the blue color filter layer is less than a thickness of the green color filter layer, and the thickness of the green color filter layer is less than a thickness of the red color filter layer, so as to enable the chromaticity coordinates of the brightness enhancement film to be changed in a direction toward red.

In yet another alternative embodiment of the present disclosure, a thickness of the blue color filter layer is less than a thickness of the green color filter layer, and a thickness of the red color filter layer is less than the thickness of the green color filter layer, so as to enable the chromaticity coordinates of the brightness enhancement film to be changed in a direction toward green.

To be specific, the color filter layers may include one color filter layer with a larger thickness and two color filter layers with an identical thickness. For example, in the case that the blue color filter layer has a thickness less than a thickness of the green color filter layer and the red color filter layer has a thickness less than the thickness of the green color filter layer, the thickness of the blue color filter layer may be identical to that of the red color filter layer. In this way, it is able to control the chromaticity coordinates of the brightness enhancement film in a better manner. During the actual application, it is able to adjust the thickness of the color filter layers in accordance with the desired chromaticity coordinates.

Further, apart from the color filter layers, the brightness enhancement film may include, one on top of the other, a plurality of uniaxial optical layers and a plurality of biaxial optical layers arranged alternately. In this way, it is able to control an emergent angle of the light beam passing through the brightness enhancement film, and reflect the light beam with an incident angle within a certain range back to the backlight module, thereby to reuse the reflected light beam and improve the light utilization rate.

The present disclosure further provides in some embodiments a backlight module, which includes the above-mentioned brightness enhancement film, a backlight source and a light guide plate. Because the brightness enhancement film includes the color filter layers in an identical color or in two different colors, the chromaticity coordinates of the brightness enhancement film are not constant any more. In addition, the chromaticity coordinates of the brightness enhancement film vary along with variation of the constitution of the color filter layers, so it is able to change the chromaticity coordinates of the backlight module by adjusting the constitution of the color filter layers. As a result, it is able to meet the requirements on the different white-light chromaticity coordinates of the display device and ensure the brightness of the display device.

The present disclosure further provides in some embodiments a display device, which includes the above-mentioned backlight module and a display panel.

Because the brightness enhancement film of the backlight module includes the color filter layers in an identical color or in two different colors, the chromaticity coordinates of the backlight module are not constant any more. In addition, the chromaticity coordinates of the backlight module vary along with variation of the constitution of the color filter layers, so it is able to change the chromaticity coordinates of the display device by adjusting the constitution of the color filter layers. As a result, it is able to meet the requirements on the different white-light chromaticity coordinates of the display device and ensure the brightness of the display device.

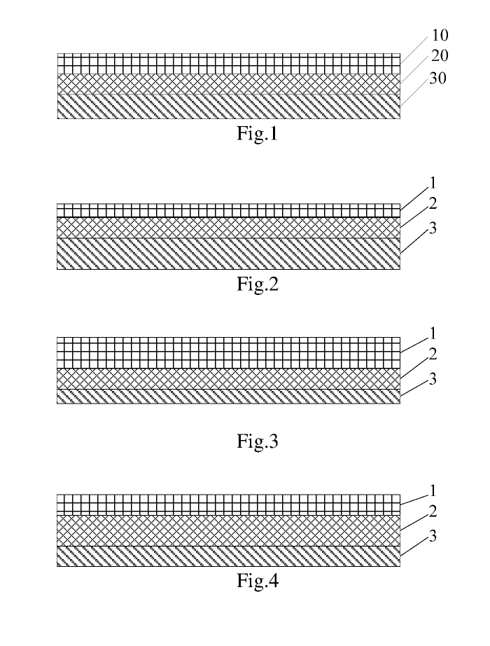

As shown in FIG. 1, in the related art, the color filter layers of the brightness enhancement film include a green color filter layer 20, a blue color filter layer 30 and a red color filter layer 10. These three color filter layers have an identical thickness, so the white-light chromaticity coordinates of the brightness enhancement film are constant. In the case that the red color filter layer 1, the green color filter layer 20 and the blue color filter layer 30 each have a thickness of 1.4 nm, the chromaticity coordinates of a white (W) light beam, and a R primary color, a G primary color, a B primary color of the brightness enhancement film are shown in Table 1.

TABLE 1

| | | x | y |
|---|---|---|---|
| RGB | R | 0.627 | 0.352 |
| | G | 0.350 | 0.612 |
| | B | 0.152 | 0.049 |
| | W | 0.3030 | 0.2946 |

In order to meet the requirements on different white-light chromaticity coordinates, in the embodiments of the present disclosure, one of a green color filter layer 2, a red color filter layer 1 and a blue color filter layer 3 of the color filter layers included in the brightness enhancement film has a thickness different from any one of thicknesses of the other two color filter layers.

In an embodiment, as shown in FIG. 2, the red color filter layer 1 has a thickness less than a thickness of the green color filter layer 2, and the green color filter layer 2 has the thickness less than a thickness of the blue color filter layer 3, so as to enable the chromaticity coordinates of the brightness enhancement film to be changed in a direction toward blue. At this time, the white-light chromaticity coordinates of the backlight module including the brightness enhancement film as well as the white-light chromaticity coordinates of the display device including the backlight module may be changed in a direction toward blue too.

In the case that the red color filter layer 1 has a thickness of 1.3 nm, the green color filter layer 2 has a thickness of 1.4 nm and the blue color filter layer 3 has a thickness of 1.5 nm, the chromaticity coordinates of a R primary color, a G primary color, a B primary color and a W light beam of the brightness enhancement film are shown in Table 2.

TABLE 2

| | | x | y |
|---|---|---|---|
| RGB | R | 0.623 | 0.353 |
| | G | 0.349 | 0.612 |
| | B | 0.152 | 0.048 |
| | W | 0.2952 | 0.2855 |

In the case that the red color filter layer 1 has a thickness of 1.2 nm, the green color filter layer 2 has a thickness of 1.4 nm and the blue color filter layer 3 has a thickness of 1.6 nm, the chromaticity coordinates of the W light beam, and the R primary color, the G primary color, and the B primary color of the brightness enhancement film are shown in Table 3.

TABLE 3

| | | x | y |
|---|---|---|---|
| RGB | R | 0.619 | 0.353 |
| | G | 0.348 | 0.611 |
| | B | 0.152 | 0.045 |
| | W | 0.2931 | 0.2775 |

It can be seen from the above that, along with the increase in the thickness of the blue color filter layer, the white-light chromaticity coordinates of the brightness enhancement film may be changed in a direction toward blue.

Alternatively, as shown in FIG. 3, the red color filter layer 1 has a thickness greater than a thickness of the green color filter layer 2, and the green color filter layer 2 has the thickness greater than a thickness of the blue color filter layer 3, so as to enable the chromaticity coordinates of the brightness enhancement film to be changed in a direction toward red. At this time, the white-light chromaticity coordinates of the backlight module including the brightness enhancement film as well as the white-light chromaticity coordinates of the display device including the backlight module may be changed in a direction toward red too.

In the case that the red color filter layer 1 has a thickness of 1.5 nm, the green color filter layer 2 has a thickness of 1.4 nm and the blue color filter layer 3 has a thickness of 1.3 nm, the chromaticity coordinates of the W light beam, and the R primary color, the G primary color, and the B primary color of the brightness enhancement film are shown in Table 4.

TABLE 4

| | | x | y |
|---|---|---|---|
| RGB | R | 0.619 | 0.353 |
| | G | 0.348 | 0.611 |
| | B | 0.152 | 0.045 |
| | W | 0.3085 | 0.3040 |

In the case that the red color filter layer 1 has a thickness of 1.6 nm, the green color filter layer 2 has a thickness of 1.4 nm and the blue color filter layer 3 has a thickness of 1.2 nm, the chromaticity coordinates of the W light beam, and the R primary color, the G primary color, and the B primary color of the brightness enhancement film are shown in Table 5.

TABLE 5

| | | x | y |
|---|---|---|---|
| RGB | R | 0.619 | 0.353 |
| | G | 0.348 | 0.611 |
| | B | 0.152 | 0.045 |
| | W | 0.3143 | 0.3142 |

It can be seen from the above that, along with the increase in the thickness of the red color filter layer, the white-light chromaticity coordinates of the brightness enhancement film may be changed in a direction toward red.

Alternatively, as shown in FIG. 4, the red color filter layer 1 has a thickness less than a thickness of the green color filter layer 2, the green color filter layer 2 has the thickness greater than a thickness of the blue color filter layer 3, and the thickness of the red color filter layer 1 is identical to the thickness of the blue color filter layer 3, so as to enable the chromaticity coordinates of the brightness enhancement film to be changed in a direction toward green. At this time, the white-light chromaticity coordinates of the backlight module including the brightness enhancement film as well as the white-light chromaticity coordinates of the display device including the backlight module may be changed in a direction toward green too.

In the case that the red color filter layer 1 has a thickness of 1.3 nm, the green color filter layer 2 has a thickness of 1.5 nm and the blue color filter layer 3 has a thickness of 1.3 nm, the chromaticity coordinates of the W light beam, and the R primary color, the G primary color, and the B primary color of the brightness enhancement film are shown in Table 6.

TABLE 6

| | | x | y |
|---|---|---|---|
| RGB | R | 0.619 | 0.353 |
| | G | 0.348 | 0.611 |
| | B | 0.152 | 0.045 |
| | W | 0.3131 | 0.3128 |

In the case that the red color filter layer 1 has a thickness of 1.2 nm, the green color filter layer 2 has a thickness of 1.6 nm and the blue color filter layer 3 has a thickness of 1.2 nm, the chromaticity coordinates of the W light beam, and the R primary color, the G primary color, and the B primary color of the brightness enhancement film are shown in Table 7.

TABLE 7

| | | x | y |
|---|---|---|---|
| RGB | R | 0.619 | 0.353 |
| | G | 0.348 | 0.611 |
| | B | 0.152 | 0.045 |
| | W | 0.3231 | 0.3310 |

It can be seen from the above that, along with the increase in the thickness of the green color filter layer, the white-light chromaticity coordinates of the brightness enhancement film may be changed in a direction toward green. During the actual application, it is able to obtain the desired white-light chromaticity coordinates by adjusting the thickness of the color filter layer.

Furthermore, in addition to the color filter layers, the brightness enhancement film may further include, one on top of the other, a plurality of uniaxial optical layers and a plurality of biaxial optical layers arranged alternately. In this way, it is able to control an emergent angle of the light beam passing through the brightness enhancement film, and reflect the light beam with an incident angle within a certain range back to the backlight module, thereby to reuse the reflected light beam and improve the light utilization rate.

According to the embodiments of the present disclosure, it is able to change the chromaticity coordinates of the brightness enhancement film by adjusting the thickness of the color filter layer. In this way, it is merely required to select the appropriate brightness enhancement film, without any change in the other components of the backlight module, so as to meet the requirements of the backlight module on different white-light chromaticity coordinates. Further, it is merely required to select the appropriate backlight nodule, without any change in the other components of the display device, so as to meet the requirements of the display device on different white-light chromaticity coordinates. Moreover, it is unnecessary to adjust the white-light chromaticity coordinates by changing the light-transmission area of the sub-pixel region, so it is able to ensure the brightness of the display device.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A brightness enhancement film, comprising a plurality of color filter layers in different colors, wherein the color filter layer in one color has a thickness different from any one of thicknesses of the color filter layers in the other colors.

2. The brightness enhancement film according to claim 1, wherein the color filter layer in one color has a thickness greater than any one of thicknesses of the color filter layers in the other colors.

3. The brightness enhancement film according to claim 2, wherein the plurality of color filter layers in different colors comprises a red color filter layer, a blue color filter layer and a green color filter layer.

4. The brightness enhancement film according to claim 3, wherein a thickness of the red color filter layer is less than a thickness of the green color filter layer, and the thickness of the green color filter layer is less than a thickness of the blue color filter layer.

5. The brightness enhancement film according to claim 3, wherein a thickness of the blue color filter layer is less than a thickness of the green color filter layer, and the thickness of the green color filter layer is less than a thickness of the red color filter layer.

6. The brightness enhancement film according to claim 3, wherein a thickness of the blue color filter layer is less than a thickness of the green color filter layer, and a thickness of the red color filter layer is less than the thickness of the green color filter layer.

7. The brightness enhancement film according to claim 6, wherein the thickness of the blue color filter layer is identical to the thickness of the red color filter layer.

8. The brightness enhancement film according to claim 1, further comprising, one on top of the other, a plurality of uniaxial optical layers and a plurality of biaxial optical layers arranged alternately.

9. A backlight module, comprising a backlight source, a light guide plate, and the brightness enhancement film according to claim 1.

10. The backlight module according to claim 9, wherein the color filter layer in one color has a thickness greater than any one of thicknesses of the color filter layers in the other colors.

11. The backlight module according to claim 10, wherein the plurality of color filter layers in different colors comprises a red color filter layer, a blue color filter layer and a green color filter layer.

12. The backlight module according to claim 11, wherein a thickness of the red color filter layer is less than a thickness of the green color filter layer, and the thickness of the green color filter layer is less than a thickness of the blue color filter layer.

13. The backlight module according to claim 11, wherein a thickness of the blue color filter layer is less than a thickness of the green color filter layer, and the thickness of the green color filter layer is less than a thickness of the red color filter layer.

14. The backlight module according to claim 11, wherein a thickness of the blue color filter layer is less than a thickness of the green color filter layer, and a thickness of the red color filter layer is less than the thickness of the green color filter layer.

15. The backlight module according to claim 14, wherein the thickness of the blue color filter layer is identical to the thickness of the red color filter layer.

16. The backlight module according to claim 9, wherein the brightness enhancement film further comprises, one on top of the other, a plurality of uniaxial optical layers and a plurality of biaxial optical layers arranged alternately.

17. A display device, comprising a display panel and the backlight module according to claim 9.

18. The display device according to claim 17, wherein the color filter layer in one color has a thickness greater than any one of thicknesses of the color filter layers in the other colors.

19. The display device according to claim 18, wherein the plurality of color filter layers in different colors comprises a red color filter layer, a blue color filter layer and a green color filter layer.

20. The display device according to claim 19, wherein a thickness of the red color filter layer is less than a thickness of the green color filter layer, and the thickness of the green color filter layer is less than a thickness of the blue color filter layer.
